(19) United States
(12) Patent Application Publication
(10) Pub. No.: US 2015/0028174 A1
(43) Pub. Date: Jan. 29, 2015

(54) CAMERA MOUNTING BRACKET

(71) Applicant: Jeffrey D. Carnevali, Seattle, WA (US)

(72) Inventor: Jeffrey D. Carnevali, Seattle, WA (US)

(21) Appl. No.: 13/952,660

(22) Filed: Jul. 28, 2013

(51) Int. Cl. F16M 13/02

(52) U.S. Cl. CPC F16M 13/02
USPC 248/316.1

(57) ABSTRACT

A mounting bracket for a device having at least one planar mounting shoe surface comprising a pair of parallel conventional T-slots each having a lengthwise T-shaped cavity formed with a wide base and a narrow opening communicating with the mounting shoe surface between parallel rails spaced apart on opposite sides of the opening, the mounting bracket has a rigid frame with a mounting surface; a pair of parallel guides spaced apart on the mounting surface of the frame; and a clamp. The clamp has a clamping jaw that is movable normal to the mounting surface, the clamping jaw has at least one arm aligned with one of the guides, and an anchor member positioned at a distal end thereof. The clamp also has an actuator that is coupled for moving the anchor member normal to the mounting surface of the frame.

### FIELD OF THE INVENTION

The present invention relates to a mounting bracket suitable for operation with a camera or other device having a mounting bracket composed of at least one planar mounting surface formed with a pair of parallel conventional T-slots, wherein each T-slot has a T-shaped lengthwise cavity formed with a wide base and a narrow opening communicating with the planar mounting surface between parallel rails spaced apart on opposite sides of the opening, and in particular to a mounting bracket having guides arranged for engaging the openings of the pair of T-slots of the mounting bracket, and a clamp mechanism cooperating with the pair of T-slots for securing the mounting bracket to the mounting bracket.

### BACKGROUND OF THE INVENTION

Bracket-mountable devices, and in particular cameras manufactured by Contour, Inc. of Seattle, Wash., are known to be formed having a mounting bracket composed of a pair of opposing planar mounting surfaces each formed with a pair of parallel conventional T-slots.

Brackets for mounting such devices are generally well known, including several manufactured specifically for the Contour camera. These mounting brackets generally provide a structure for connecting with the T-slots on the mounting bracket.

However, known bracket mounts for such bracket-mountable devices are limited in their ability to provide efficient and reliable mounting.

### SUMMARY OF THE INVENTION

The present invention is a mounting bracket for a device having at least one planar mounting shoe surface comprising a pair of parallel conventional T-slots each having a lengthwise T-shaped cavity formed with a wide base and a narrow opening communicating with the mounting shoe surface between parallel rails spaced apart on opposite sides of the opening, the mounting bracket has a rigid frame with a mounting surface; a pair of parallel guides spaced apart on the mounting surface of the frame; and a clamp. The clamp has a clamping jaw that is movable normal to the mounting surface, the clamping jaw has at least one arm aligned with one of the guides, and an anchor member positioned at a distal end thereof. The clamp also has an actuator that is coupled for moving the anchor member normal to the mounting surface of the frame.

According to one aspect of the invention, the clamping jaw of the mounting bracket includes a pair of arms each aligned between first and second spaced-apart portions of one of the pair of guides, and each of the arms has an anchor member positioned adjacent to a distal end thereof.

According to another aspect of the invention, the actuator of the mounting bracket is threadedly coupled to the clamping jaw.

According to another aspect of the invention, the frame of the mounting bracket includes a connection structure having an axis about which the mounting surface is symmetric.

Other aspects of the invention are detailed herein.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 shows an example of a bracket-mountable device of the prior art, such as a camera manufactured by Contour, Inc. of Seattle, Wash.;

FIG. 2 illustrates the bracket-mountable device illustrated in FIG. 1 mounted on a mounting bracket of the invention;

FIG. 3 illustrates one perspective of the mounting of the bracket-mountable device of the prior art onto the mounting bracket of the invention illustrated in FIG. 2;

FIG. 4 illustrates another perspective of the mounting of the bracket-mountable device of the prior art onto the mounting bracket of the invention illustrated in FIG. 2;

FIG. 5 and FIG. 6 illustrate different stages of the mounting of the bracket-mountable device of the prior art onto the mounting bracket of the invention illustrated in FIG. 2;

FIG. 7 illustrates another perspective of the bracket-mountable device illustrated in FIG. 1 mounted on the mounting bracket of the invention illustrated in FIG. 2; and

FIG. 8 and FIG. 9 illustrate different stages of the mounting of the bracket-mountable device of the prior art onto the mounting bracket of the invention illustrated in FIG. 2.

### DETAILED DESCRIPTION OF PREFERRED EMBODIMENT

As required, a detailed illustrative embodiment of the present mounting bracket is disclosed herein. However, techniques, systems and operating structures in accordance with the present mounting bracket may be embodied in a wide variety of forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein which define the scope of the present mounting bracket. The following presents a detailed description of an illustrative embodiment (as well as some alternative embodiments) of the present mounting bracket.

In the Figures, like numerals indicate like elements.

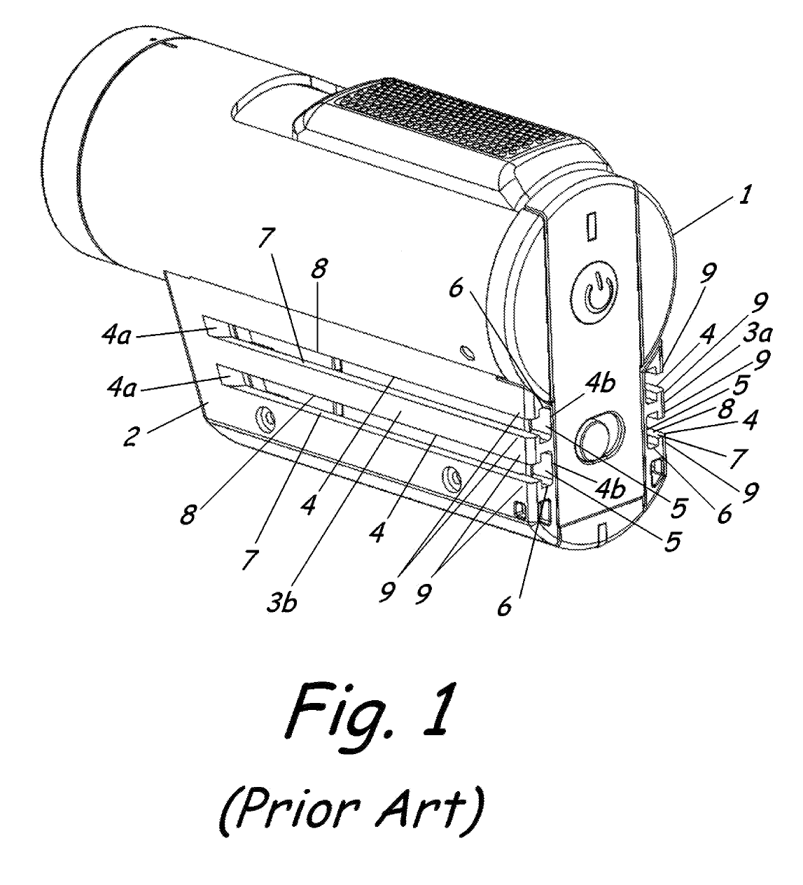

FIG. 1 illustrates a bracket-mountable device, such as a camera device 1 generally of the type manufactured by Contour, Inc. of Seattle, Wash. Such camera and other bracket-mountable devices 1 are known to be formed having a mounting shoe 2 composed of a pair of opposing planar mounting surfaces 3a (far) and 3b (near) spaced apart substantially on each side of device 1. Each mounting surface 3a, 3b is substantially a minor image of the other. Each mounting surface 3a, 3b is formed with a pair of parallel conventional T-slots 4, wherein each T-slot 4 has a T-shaped lengthwise cavity 5 formed with a wide base portion 6 communicating with a narrow lengthwise gap 7 leading to an opening 8 that communicates with respective planar mounting surface 3a, 3b between parallel rails 9 that are spaced apart on opposite sides of opening 8. Optionally, each T-slot 4 terminates at its distal end in a stop 4a which operates for positioning a mounting bracket. T-slots 4 have open entrances 4b thereinto at proximate ends of lengthwise cavities 5 opposite from stops 4a for receiving a mounting bracket thereinto.

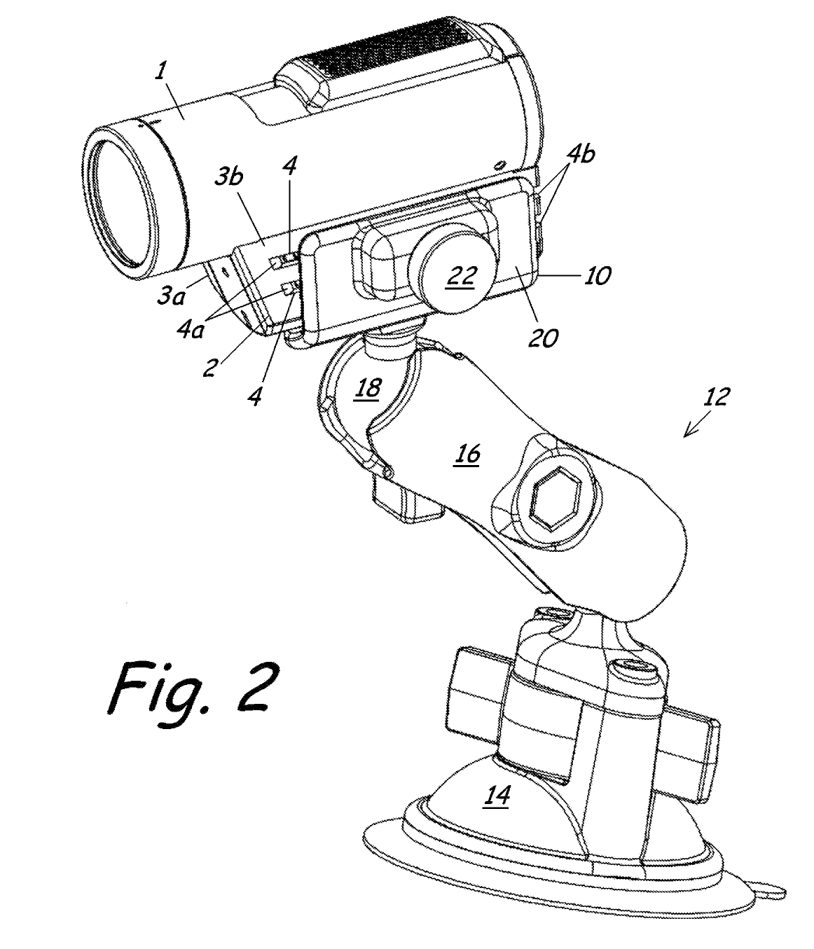

FIG. 2 illustrates a mounting bracket 10 of the invention for a bracket-mountable device, such as a camera device 1 generally of the type manufactured by Contour, Inc., or another device having a mounting shoe 2 generally of the type illustrated in FIG. 1. Mounting bracket 10 is adapted for mounting and dismounting of such device 1, and further permits full reversal of device 1 thereon. Mounting bracket 10 is adapted for being received by T-slots 4 of either of opposing, substantially mirror image mounting surfaces 3a, 3b of mounting shoe 2 for holding camera or other device 1. Here, device 1 is mounted on mounting bracket 10 at surface 3b of mounting shoe 2. Mounting bracket 10 is similarly mountable at mirror surface 3a of mounting shoe 2, as disclosed herein. Mounting bracket 10 is further adapted for coupling to a stand 12, such as but not limited to a suction cup mount 14 through, for example, a ball-and-socket connector 16. Here, by example and without limitation, mounting bracket 10 is shown having connection structure 18, such as a ball coupler adapted to cooperate with ball-and-socket connector 16, for clamping device 1 in a desired position in a desired attitude with a desired orientation. Accordingly, frame 20 is pivotable about ball coupler-type connection structure 18.

Mounting bracket 10 includes a rigid frame 20 for rigidly maintaining the desired position in a desired attitude with a desired orientation of camera or other device 1. Frame 20 is by example and without limitation generally “L” or “J” shaped with ball coupler or other connection structure 18 is extended from the base thereof, whereby mounting bracket 10 is structured to avoid interference with device 1 while permitting reverse mounting on frame 20.

Operation of an actuator 22 permits both quick mounting and dismounting of camera or other device 1, as disclosed more fully herein.

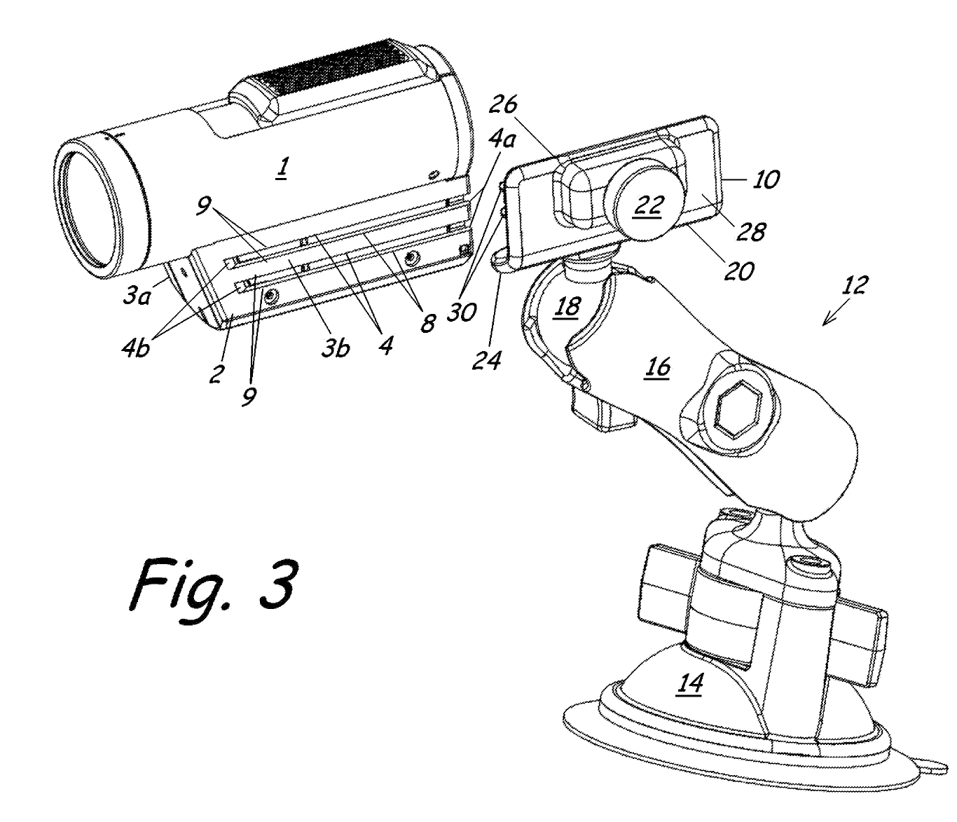

FIG. 3 illustrates an initial relative orientation of mountable device 1 with mounting bracket 10. Mounting shoe 2 of device 1 is positioned slightly above a base portion 24 of frame 20 with one of its mounting surfaces 3a, 3b (shown) adjacent to a mounting surface 26 on a backing plate 28 of frame 20. T-slots 4 of mounting shoe 2 are aligned with a pair of guides 30 of mounting bracket 10, with guides 30 positioned adjacent to open entrances 4b into corresponding T-slots 4.

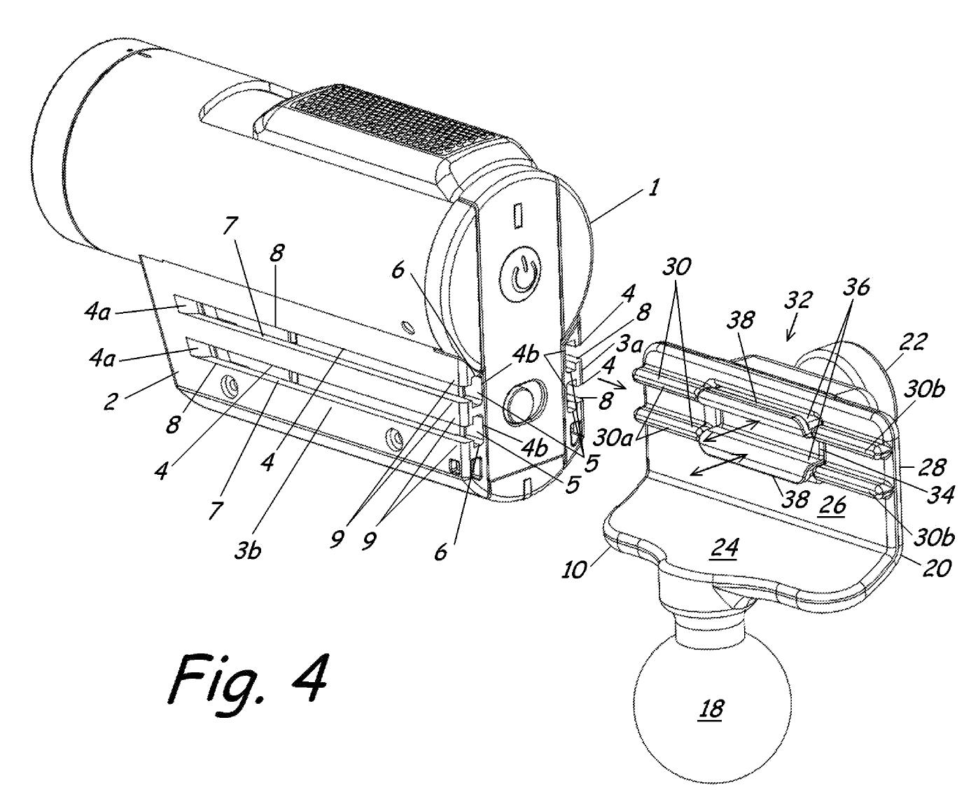

FIG. 4 is another view that an initial relative orientation of mountable device 1 with mounting bracket 10. Mounting shoe 2 of device 1 is positioned slightly above base portion 24 of frame 20 with one of its mounting surfaces 3a, 3b adjacent to mounting surface 26 on backing plate 28 of frame 20. T-slots 4 of mounting shoe 2 are aligned with parallel guides 30 of mounting bracket 10. Each guide 30 is configured with first and second spaced-apart portions 30a, 30b each sized to fit through openings 8 into narrow lengthwise gap 7 formed in pair of parallel T-slots 4 of mounting shoe 2. Guide portions 30a, 30b are arranged on mounting surface 26 of frame backing plate 28 for slidingly engaging parallel T-slot openings 8 into narrow lengthwise gap 7 of mounting shoe 2. Guides 30 are positioned adjacent to open entrances 4b into corresponding T-slots 4 for sliding engagement therewith.

As shown here, first portions 30a operate as leading edges of guide 30 for entering entrances 4b and engaging corresponding T-slots 4. However, when camera or other device 1 is reversed, opposite second portions 30b operate as leading edges of guide 30 for entering entrances 4b and engaging corresponding T-slots 4.

When present, end stops 4a may be utilized to position guides 30 relative to corresponding T-slots 4.

Mounting bracket 10 includes a clamp 32 adapted for securing one of mounting surfaces 3a, 3b of mounting shoe 2 of device 1 against mounting surface 26 on backing plate 28 of frame 20. Clamp 32 includes a clamping jaw 34 having a pair of arms 36 aligned between first and second spaced-apart guide portions 30a, 30b of guide 30. Arms 36 of clamping jaw 34 are sized for slidingly engaging parallel T-slot openings 8 of mounting shoe 2. Each arm 36 is formed with an anchor member 38 adjacent to a distal end thereof. Anchor members 38 are adapted for slidingly engaging base portion 6 of lengthwise cavity 5 of one of T-slots 4 and sized larger than opening 8 thereinto. Clamp 32 is movable normal to mounting surface 26 on backing plate 28. Accordingly, when actuator 22 is initially operated to advance (arrows) clamping jaw 34 outwardly away from mounting surface 26 of frame backing plate 28, arms 36 and anchor members 38 of clamp 32 are positioned for insertion into T-slots 4 through open entrances 4b thereinto. In other words, arms 36 of clamp 32 are positioned to enter narrow lengthwise gaps 7 at openings 8 in T-slots 4, with anchor members 38 positioned to enter T-shaped lengthwise cavity 5 on opposite side of rails 9 from frame backing plate 28. After insertion, when actuator 22 is operated to retract (arrows) clamping jaw 34 inwardly toward mounting surface 26 of frame backing plate 28, anchor members 38 of arms 36 are retained by T-slots 4 by lodging in narrow lengthwise gaps 7 at openings 8 with T-slot rails 9 between anchors 38 and frame backing plate 28. Continued retraction of clamping jaws 34 squeeze rails 9 of T-slots 4 against backing plate 28 of frame 20, whereby minor mounting surface 3a of mounting shoe 2 is secured against mounting surface 26 of frame backing plate 28.

When present, end stops 4a may be utilized to position clamping jaw 34 relative to corresponding T-slots 4, in addition to positioning guides 30.

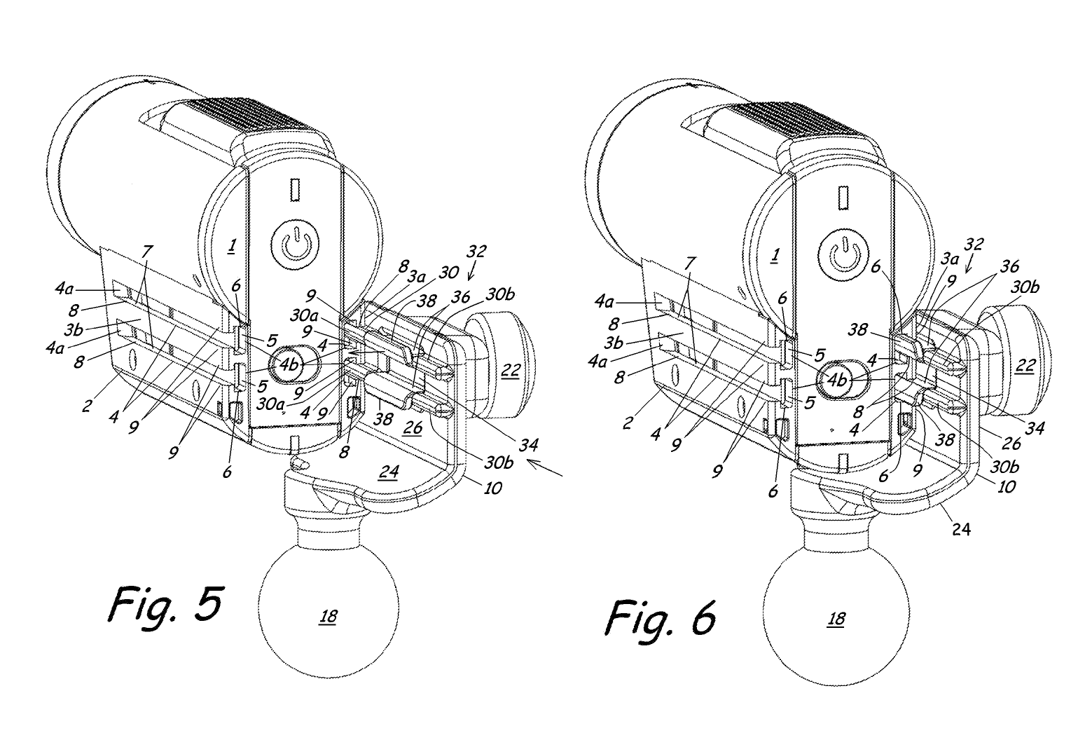

FIG. 5 illustrates a first partial engagement of mountable device 1 with mounting bracket 10. First portions 30a of guides 30 are entered into entrances 4b and engage with corresponding T-slots 4 in mounting surface 3a of mounting shoe 2. First guide potions 30a are fitted through corresponding openings 8 of parallel T-slots 4 and into lengthwise T-slots cavities 5.

Clamp 32 is initially configured with clamping jaw 34 in an installation condition wherein arms 36 are extended from mounting surface 26 of frame backing plate 28. Accordingly, anchor members 38 of arms 36 are positioned to enter wide base portion 6 of T-shaped lengthwise cavity 5 under rails 9 that are spaced apart on opposite sides of opening 8.

FIG. 6 illustrates a second partial engagement of mountable device 1 with mounting bracket 10. Here, first portions 30a of guides 30 are disposed in openings 8 and engaged with corresponding T-slots 4. Arms 36 of extended clamping jaw 34 are entering entrances 4b and engaging corresponding T-slots 4 in mounting surface 3a of mounting shoe 2. Clamping jaw arms 36 are fitted through corresponding openings 8 of parallel T-slots 4 and into lengthwise T-slots cavities 5. Simultaneously, anchor members 38 of arms 36 are entered and engaged with corresponding wide base portions 6 of T-shaped lengthwise cavity 5 under rails 9 that are spaced apart on opposite sides of opening 8.

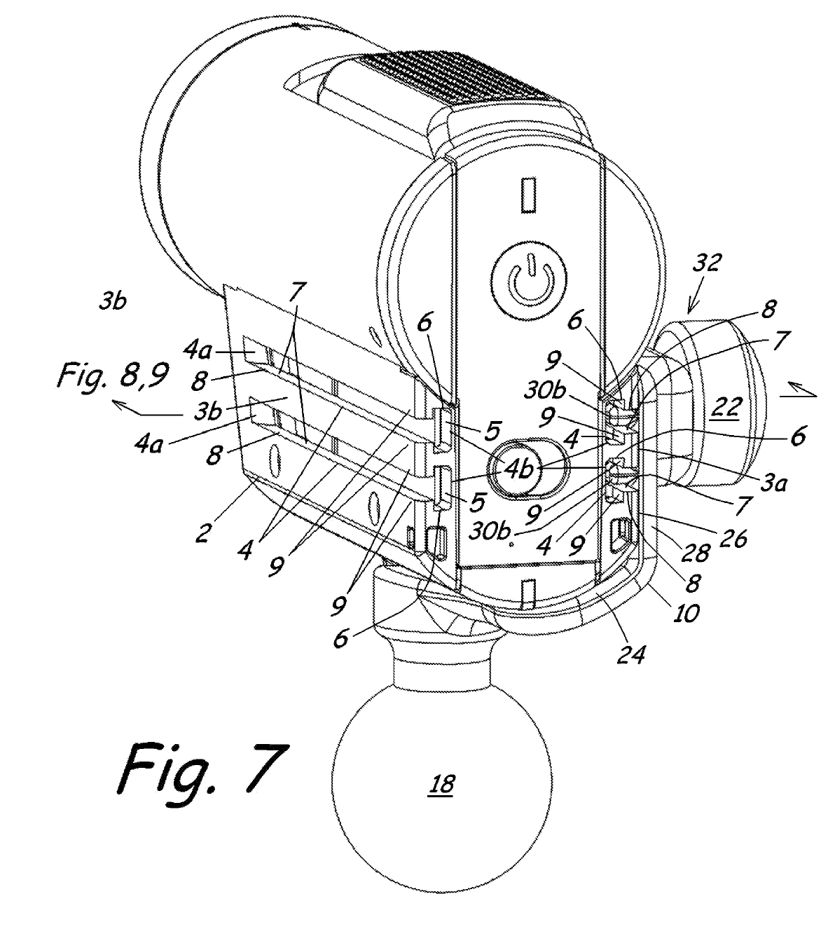

FIG. 7 illustrates full engagement of mountable device 1 with mounting bracket 10. Here, guides 30 are completely disposed in openings 8 and engaged with corresponding T-slots 4. Arms 36 of extended clamping jaw 34 are completely disposed in openings 8 and engaged with corresponding T-slots 4 in mounting surface 3a of mounting shoe 2. Clamping jaw arms 36 are completely disposed in corresponding openings 8 of parallel T-slots 4 and lengthwise T-slots cavities 5. Simultaneously, anchor members 38 of arms 36 are completely disposed in and engaged with corresponding wide base portions 6 of T-shaped lengthwise cavity 5 under rails 9 that are spaced apart on opposite sides of opening 8.

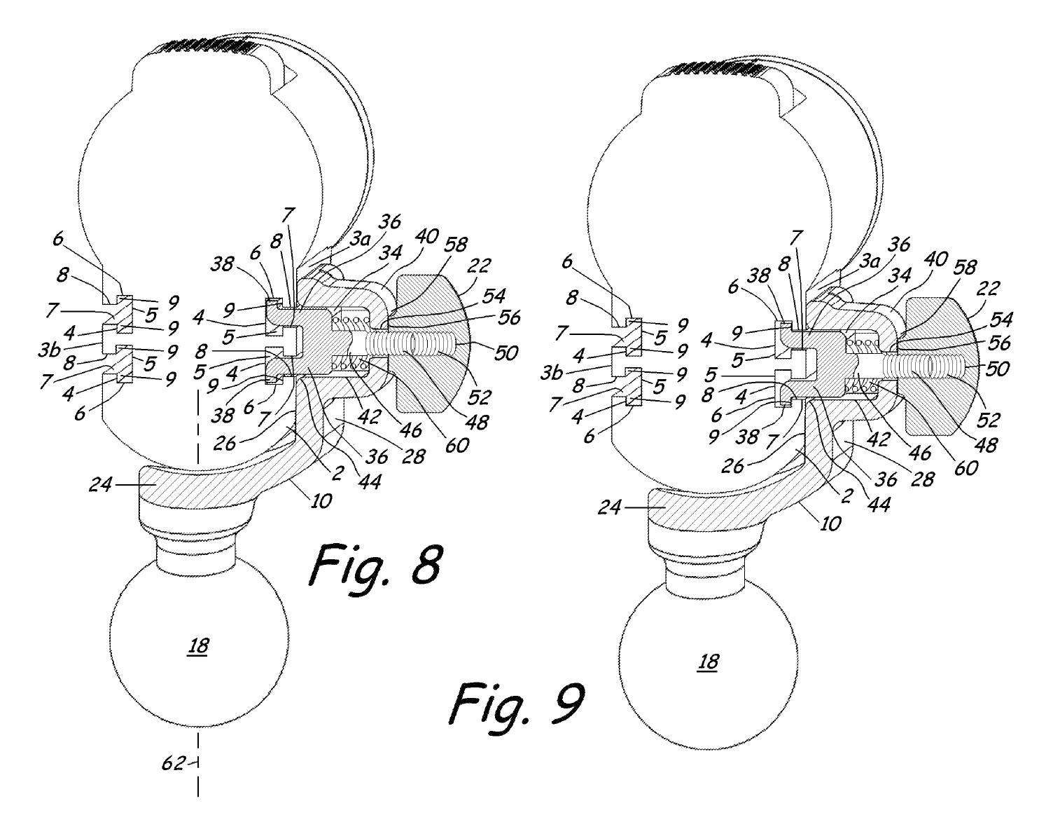

FIG. 8 is a cross-section view taken through mountable device 1 being installed on mounting bracket 10 as illustrated in FIG. 7. Here, backing plate 28 of frame 20 is formed with a hollow block 40 housing a guide chamber 42 that is recessed into mounting surface 26 and communicates therewith through an opening 44.

Actuator 22 is coupled for moving clamping jaw 34 along guide chamber 42 for engaging anchor members 38 thereof with T-slots 4 in mounting surface 3a of mounting shoe 2, whereby clamp 32 secures rail portions 9 of T-slots 4 against mounting surface 26 of frame 20. By example and without limitation, actuator 22 is coupled by threaded engagement with a stud 46 projected from clamping jaw 34 opposite from clamping arms 36 thereof. For example, stud 46 is formed with male threads 48, and actuator 22 is formed with a female shaft 50 formed with mating threads 52. Clamping jaw 34 communicates with actuator 22 by means of threaded stud 46 which passes through an aperture 54 in distal portion of block 40. Actuator 22 threadedly couples with clamping jaw 34 through cooperating threaded stud 46 engaging threaded shaft 50. Thereafter actuator 22 operates clamping jaw 34 by turning an actuator interface surface 56 against a cooperating clamp interface surface 58 for drawing stud 46 outwardly of aperture 54, whereby clamping jaw 34 into a retracted state relative to mounting surface 26 of frame 20. Alternatively, actuator 22 operates for relaxing retraction force of clamp 32 by reverse turning of actuator interface surface 56 against cooperating clamp interface surface 58, whereby clamping jaw 34 is permitted to move outwardly of recessed guide chamber 42 into an extended state relative to mounting surface 26 of frame 20, as illustrated here.

When mounting bracket 10 is configured with the clamping jaw 34 of clamp 32 in the extended state relative to mounting surface 26 of frame 20, clamping jaw arms 36 are aligned between first and second spaced-apart guide portions 30a, 30b of guide 30 for slidingly engaging narrow lengthwise gaps 7 into T-slots 4 at openings 8, and anchor members 38 are positioned for slidingly engaging base portions 6 of lengthwise cavities 5 of T-slots 4. Additionally, the extended state of clamping jaw 34 relative to frame mounting surface 26 eliminates retraction tension on clamping jaw 34, whereby anchor members 38 may slidingly engage base portions 6 of T-slots 4 without exerting clamping pressure on rail portions 9 of T-slots 4.

Optionally, a biasing member 60 is positioned for urging outwardly of recessed guide chamber 42 into the extended state relative to frame mounting surface 26 when actuator 22 is in the relaxed condition. For example, when present biasing member 60 is a spring contained in guide chamber 42 between clamping jaw 34 and distal portion of block 40.

As disclosed herein, mounting bracket 10 is adapted for further permits full reversal of device 1 thereon. Accordingly, clamp 32 is formed on a plane cutting through an axis 62 formed through connection structure 18. Connection structure 18 is mounted on frame 20 such that mounting bracket 10 is symmetrical across axis 62 across the plane cutting through both clamp 32 and axis 62.

FIG. 9 is another cross-section view taken through mountable device 1 being installed on mounting bracket 10 as illustrated in FIG. 7. However, here mounting bracket 10 is configured with the clamping jaw 34 in the retracted state relative to mounting surface 26 of frame 20.

Here, actuator 22 is operated for exerting a retraction force on clamping jaw 34 on by reverse turning of actuator interface surface 56 against cooperating clamp interface surface 58. Accordingly, threaded action between mating threads 48 and 52 of clamping jaw stud 46 and threaded mated actuator shaft 50 force clamping jaw 34 to move inwardly of recessed guide chamber 42 into the retracted state relative to mounting surface 26 of frame 20. Thus, actuator 22 operates for tensioning the retraction force on anchor members 38 adjacent to distal ends of clamping jaw arms 36. Anchor members 38 are structured for slidingly engaging wide base portion 6 of lengthwise cavity 5 of T-slots 4 and interfering with narrow opening 8 thereinto. Anchor members 38 are, for example, hook-shaped members arranged for engaging undersurfaces of T-slot rails 9. Anchor members 38 thus clampingly grip undersurfaces of T-slot rails 9 for squeezing rails 9 of T-slots 4 against backing plate 28 of frame 20, whereby mounting surface 3a of mounting shoe 2 is secured against mounting surface 26 of frame backing plate 28.

While the preferred and additional alternative embodiments of the invention have been illustrated and described, it will be appreciated that various changes can be made therein without departing from the spirit and scope of the invention. Therefore, it will be appreciated that various changes can be made therein without departing from the spirit and scope of the invention. Accordingly, the inventor makes the following claims.

What is claimed is:

1. A mounting bracket, comprising:
a rigid frame comprising a recessed guide chamber communicating with a mounting surface thereof;
a pair of parallel guides aligned with the recessed guide chamber on the mounting surface of the frame, each guide arranged for slidingly engaging openings formed in a pair of parallel T-slots; and
a clamp, comprising:
a clamping jaw that is movable in the guide chamber, the clamping jaw having at least one arm aligned with one of the guides, and wherein the arm comprises an anchor member adapted for slidingly engaging one of the T-slots and clamping therewith, and
an actuator coupled for moving the clamping jaw along the guide chamber for engaging the anchor member with the one T-slot, whereby the clamp secures a rail portion of the one T-slot against the mounting surface of the frame.

2. The mounting bracket of claim 1, wherein at least one guide further comprises first and second spaced-apart portions each arranged for slidingly engaging an opening formed in a pair of parallel T-slots.

3. The mounting bracket of claim 2, wherein the arm of the clamping jaw is further aligned between the first and second spaced-apart portions of the guide.

4. The mounting bracket of claim 1, wherein the anchor member of the arm of the clamping jaw is further adapted for interfering with the opening formed in the T-slot.

5. The mounting bracket of claim 4, wherein the anchor member of the arm of the clamping jaw further comprises a hook-shaped member arranged for engaging an undersurface of the T-slot rail portion.

6. The mounting bracket of claim 1, wherein the frame further comprises a connection structure about which the mounting surface is symmetric.

7. The mounting bracket of claim 1, wherein the clamping jaw further comprises a pair of the arms each aligned with one of the guides, and wherein each arm comprises an anchor member adapted for slidingly engaging one of the T-slots and clamping therewith.

8. A mounting bracket, comprising:
a rigid frame comprising a recessed guide chamber communicating with a mounting surface thereof, and a connection structure about which the mounting surface is symmetric;
two parallel guides aligned with the recessed guide chamber on the mounting surface of the frame and arranged for slidingly engaging openings formed in a pair of parallel T-slots, at least one of the guides comprising first and second spaced-apart portions;
a clamp, comprising:
a clamping jaw that is slidable in the guide chamber, the clamping jaw having at least one arm extending outwardly of the guide chamber and aligned between the first and second spaced-apart portions of the one guide, and wherein the arm comprises an anchor member adjacent to a distal end thereof for slidingly engaging a base portion of one of the T-slots and adapted for clampingly engaging an undersurface of a rail portion of the T-slot; and
an actuator coupled for sliding the clamping jaw along the guide chamber for clampingly engaging the anchor member with the T-slot, whereby the clamp secures the rail portion of the T-slot against the mounting surface of the frame.

9. The mounting bracket of claim 8, wherein the connection structure further comprises an axis about which the mounting surface is symmetric.

10. The mounting bracket of claim 8, wherein the anchor member of the arm of the clamping jaw further comprises a hook-shaped member.

11. The mounting bracket of claim 10, wherein each of the two parallel guides further comprises first and second spaced-apart portions; and
wherein the clamping jaw further comprises a pair of the arms each extending outwardly of the guide chamber and aligned between the first and second spaced-apart portions of one of the guides, and each arm comprising an anchor member adjacent to a distal end thereof for slidingly engaging a base portion of one of the T-slots and adapted for clampingly engaging an undersurface of a rail portion of the T-slot; and
wherein the actuator coupled for sliding the clamping jaw along the guide chamber for clampingly engaging each of the anchor members with one of the pair of T-slots, whereby the clamp secures the rail portion of the pair of T-slots against the mounting surface of the frame.

12. The mounting bracket of claim 8, wherein the actuator is threadedly coupled to the clamping jaw.

13. The mounting bracket of claim 8, wherein the clamping jaw is further linearly slidable in the guide chamber; and
wherein the actuator is further coupled for sliding the clamping jaw linearly along the guide chamber.

14. A mounting bracket, comprising:
a rigid frame comprising a mounting surface;
a pair of parallel guides spaced apart on the mounting surface of the frame; and
a clamp, comprising:
a clamping jaw that is movable normal to the mounting surface, the clamping jaw comprising at least one arm aligned with one of the guides, and wherein the arm comprises an anchor member positioned at a distal end thereof, and
an actuator coupled for moving the anchor member normal to the mounting surface of the frame.

15. The mounting bracket of claim 14, wherein the arm of the clamping jaw is further aligned between first and second spaced-apart portions of one of the guides.

16. The mounting bracket of claim 14, wherein the clamping jaw further comprises a pair of arms each aligned between first and second spaced-apart portions of one of the pair of guides, and wherein each of the arms comprises an anchor member positioned adjacent to a distal end thereof.

17. The mounting bracket of claim 16, wherein the anchor member of each arm of the clamping jaw further comprises a hook member.

18. The mounting bracket of claim 17, further comprising a connection structure about which the frame is pivotable.

19. The mounting bracket of claim 14, further comprising a threaded joint between the actuator and the clamping jaw.

20. The mounting bracket of claim 19, wherein the frame further comprises a guide chamber that is recessed into the mounting surface thereof between the first and second spaced-apart portions of the pair of guides; and
wherein the clamping jaw is linearly movable within the guide chamber.

21. A mounting bracket for a device having at least one planar mounting shoe surface comprising a pair of parallel conventional T-slots each having a lengthwise T-shaped cavity formed with a wide base and a narrow opening communicating with the mounting shoe surface between parallel rails spaced apart on opposite sides of the opening, the mounting bracket comprising:
a rigid frame comprising a recessed guide chamber communicating with a mounting surface thereof;
a pair of parallel guides aligned with the recessed guide chamber on the mounting surface of the frame, each guide comprising first and second spaced-apart guide portions positioned on opposite sides of the guide chamber and arranged for slidingly engaging the openings of the pair of T-slots;
a clamp comprising:
a clamping jaw that is movable in the guide chamber, the clamping jaw comprising a pair of arms between the first and second spaced-apart portions of the guides and aligned therewith, and wherein each of the arms comprises a anchor member adjacent to a distal end thereof and adapted for slidingly engaging the base of the T-shaped lengthwise cavity of the pair of T-slots; and
an actuator coupled for moving the clamping jaw along the guide chamber for engaging the anchor members with the pair of T-slots, whereby the clamp secures the mounting shoe against the mounting surface of the frame.

22. The mounting bracket of claim 21, wherein the frame further comprises a connection structure comprising an axis about which the mounting surface is symmetric.
